(19) United States
(12) Patent Application Publication
(10) Pub. No.: US 2003/0232628 A1
(43) Pub. Date: Dec. 18, 2003

(54) Cordless telephone

(76) Inventor: Bjorn Fehrm, Herrsching (DE)

Correspondence Address: LERNER AND GREENBERG, P.A., Post Office Box 2480, Hollywood, FL, 33022-2480, US

(21) Appl. No.: 10/419,602

(22) Filed: Apr. 21, 2003

Related U.S. Application Data
(63) Continuation of application No. PCT/DE01/03960, filed on Oct. 17, 2001.

(30) Foreign Application Priority Data
Oct. 20, 2000 (DE) 100 52 212.2

(51) Int. Cl. H04M 1/00

(52) U.S. Cl. 455/550.1; 455/566; 455/575.3

(57) ABSTRACT

A cordless telephone has a display screen and an input screen. The display screen is arranged on a first part of the telephone, and the input screen is arranged on a second part of the telephone. The first part and the second part are joined by a hinge and can be folded together.

### CROSS-REFERENCE TO RELATED APPLICATION

This application is a continuation of copending International Application No. PCT/DE01/03960, filed Oct. 17, 2001, which designated the United States and was not published in English.

### BACKGROUND OF THE INVENTION

### FIELD OF THE INVENTION

The invention relates to a cordless telephone with a display screen and an input screen.

A cordless telephone of this kind is known, for instance from the company Qualcomm. In that model, the input screen and the display screen are built in one piece. The keyboard can be folded over the lower screen region by using a hinge-type cover.

Such telephones with a screen region for input are referred to as smart phones, which represent a combination of an electronic notebook or pocket calendar with a normal cordless telephone, for instance, a GSM (Global System for Mobile Communications) mobile phone. A smart phone can be used not only for telephoning, but also as an address book, calendar, SMS (short message service), fax, and mail, as well as for accessing the Internet, among other business applications. All applications can be overdubbed or synchronized with the PC (personal computer) by way of an interface.

The commercial success of mobile phones, that is to say smart phones, very much depends on the correct size, weight and price. As can be seen in the prior mobile phone models, it is critical to reduce the weight and size so that the mobile phone fits in a trouser or jacket pocket.

In a smart phone, the crucial elements are the display screen and the input screen. The screens are the limiting factor in the reduction of the size of the device, because the display contents would become illegible given further reduction. Furthermore, the actual screen is significantly larger than the screen that can be utilized for display purposes. For a palm pilot, for example, the screen is 70×80 mm=5600 mm², but the actual display is significantly smaller, only 56×56 mm=3136 mm² with 160×160 pixels. The rest of the screen is utilized for text input and input fields for dual functions. The display area of 3136 mm²=160×160 pixels cannot be further reduced, because this resolution already represents the lower limit of legibility.

### SUMMARY OF THE INVENTION

It is accordingly an object of the invention to provide a cordless telephone which overcomes the above-mentioned disadvantages of the prior art apparatus of this general type.

In particular, it is an object of the invention to reduce the size of a cordless telephone of the type discussed above.

With the foregoing and other objects in view there is provided, in accordance with the invention, a cordless telephone including: a first part having a display screen disposed thereon; a second part having an input screen disposed thereon; a plurality of input keys configured on the second part; and a hinge joining the first part and the second part. The hinge enables the first part and the second part to be folded together in a closed state in which an interior is defined between the first part and the second part and in which the display screen and the input screen are in the interior.

In accordance with an added feature of the invention, the second part has a back constructed as a stand surface.

In accordance with an additional feature of the invention, there is provided: an earpiece configured on the first part; and an antenna extending outside of the second part.

In accordance with a further feature of the invention, there is provided: a loudspeaker configured on the first part; and an antenna extending outside of the second part.

In accordance with a further added feature of the invention, there is provided, an input stylus inserted in the first part.

In accordance with a further additional feature of the invention, the antenna is shaped to fix the input stylus when the first part and the second part are folded together in the closed state.

In accordance with another feature of the invention, at least one battery is configured in the second part.

In accordance with another further feature of the invention, a plurality of batteries are configured in the second part.

In accordance with yet an added feature of the invention, an electronic notebook is integrated into the telephone.

In accordance with yet an additional feature of the invention, a pocket calendar is integrated into the telephone.

In accordance with yet another feature of the invention, the telephone is constructed to: execute short message service functions, execute facsimile functions, execute mail functions, execute web browser functions, execute common business applications, update data, synchronize data with a PC, and be connected to an Internet.

The object of the invention is inventively achieved by disposing the display screen on a first part of the telephone, by disposing the input screen on a second part of the telephone, and by providing a hinge connecting the two parts so that they can be folded together.

Splitting the screen into a display region and a write region makes possible a highly space-efficient telephone design. By virtue of the two foldable parts, the outer dimensions of the telephone is extremely small and a large operating surface is provided for the two screens and the keyboard in the opened condition.

In the folded condition, the two screens are advantageously arranged opposite one another on the inside. The input screen, in particular, must be protected in order to prevent inadvertent input during transport. The folded condition automatically protects both screens.

A keyboard for input is advantageously provided on the second part, and the back of the second part is constructed as a stand surface.

Thus, in practice, the second part can be placed on a table, and the display screen on the first part can be set at a right angle for the user. The keyboard and the input screen are thereby situated on the top of the second part, which is more convenient for user operation.

According to an advantageous development, an earpiece is provided on the first part, and an antenna is provided on the outside of the second part. This guarantees that the antenna is positioned on the bottom side during telephoning, so that good SAR values (microwave head emission values) are achieved.

An input stylus is advantageously attached to the first part, and is arranged so that the antenna fixes the input stylus when the telephone is in the closed condition. The stylus can thus be conveniently withdrawn once the two parts have been folded open.

Other features which are considered as characteristic for the invention are set forth in the appended claims.

Although the invention is illustrated and described herein as embodied in a cordless telephone, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a front view of the telephone in the open condition; and

FIG. 2 is a side view of the telephone in the closed condition.

### DESCRIPTION OF THE PREFERRED EMBODIMENTS

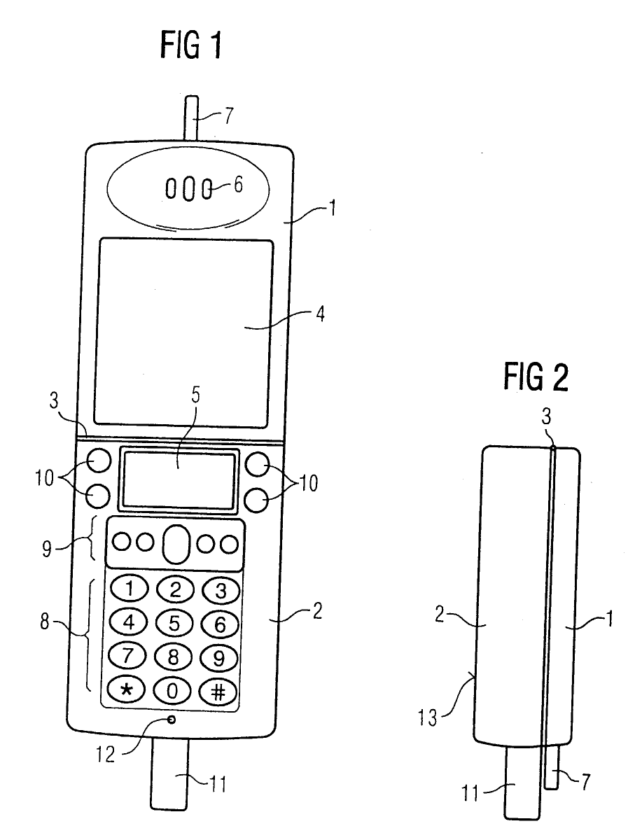

Referring now to the figures of the drawing in detail and first, particularly, to FIG. 1 thereof, there is shown an inventive telephone consisting substantially of a first part 1 and a second part 2, which are connected to one another by a hinge 3. A display screen 4 is arranged on the first part 1, and an input screen 5 is arranged on the second part 2. As represented in FIG. 2, which is a side view of the telephone in the closed condition, the two parts 1 and 2 are congruent and can be folded together compactly.

The two screens for input and display are arranged on the interior side, and thus automatically protect one another.

An earpiece 6, i.e. a type of loudspeaker, is installed on the first part 1.

An input stylus 7 is installed in the first part 1, and the input stylus 7 can be used to enter input at the screen 5.

A conventional mobile phone touchpad 8 is provided on the second part 2 beside which, keys 9 for menu control are arranged.

Additional function keys 10 are installed next to the input screen 5.

An antenna 11 is provided on the bottom of the second part 2, which also serves for fixing the input stylus 7 in the closed condition. The great advantage of arranging the antenna 11 on the bottom of the part 2 is that it is far away from the earpiece 6, so that very low emission values for the head (SAR values) can be achieved.

A microphone 12 is provided centrally underneath the touchpad 8.

With the subdivision into a display screen 4 and an input screen 5 and the provision of a hinge joint between the first part 1 and the second part 2, a cordless telephone is achieved which has external dimensions of 66 mm×100 mm×25 mm and a weight of 200 g. Without the antenna 11 and the input stylus 7, the length is 95 mm. This corresponds to the dimensions and weight of very small mobile phones by market standards, even though the input stylus 7 and the input screen 5 as well as the function keys 10 are integrated.

The exterior of the second part 2 is constructed as a stand surface 13, and it is possible to stand the cordless telephone easily on a table and fold open the first part 1 with the display screen like a notebook. The batteries are held in the second part 2, and consequently most of the weight is disposed in the second part 2 and rests stably on a table or in the hand. The input areas such as the touchpad 8, the menu control keys 9, the input screen 5, and the function keys 10 thus have a very user-friendly location on the top side of the second part given placement on a table. The input stylus 7 can be conveniently withdrawn from the open first part 1 and reinserted without special measures at the end of the input process.

Dividing the screen into two parts, namely a display screen and an input screen, brings the further advantage that the display screen is not covered during inputting; rather, all functions at the input screen can be tracked during inputting.

The inventive cordless telephone thus represents an ideal combination of a palm pilot and a GSM mobile phone with the weight and dimensions of a small mobile phone by today's commercial standards.

I claim:

1. A cordless telephone comprising:
a first part having a display screen disposed thereon;
a second part having an input screen disposed thereon;
a plurality of input keys configured on said second part; and
a hinge joining said first part and said second part;
said hinge enabling said first part and said second part to be folded together in a closed state in which an interior is defined between said first part and said second part and in which said display screen and said input screen are in said interior.

2. The cordless telephone according to claim 1, wherein said second part has a back constructed as a stand surface.

3. The cordless telephone according to claim 1, further comprising:
an earpiece configured on said first part; and
an antenna extending outside of said second part.

4. The cordless telephone according to claim 1, further comprising:
a loudspeaker configured on said first part; and
an antenna extending outside of said second part.

5. The cordless telephone according to claim 1, further comprising an input stylus inserted in said first part.

6. The cordless telephone according to claim 5, wherein said antenna is shaped to fix said input stylus when said first part and said second part are folded together in said closed state.

7. The cordless telephone according to claim 1, further comprising at least one battery configured in said second part.

8. The cordless telephone according to claim 1, further comprising a plurality of batteries configured in said second part.

9. The cordless telephone according to claim 1, further comprising an integrated electronic notebook.

10. The cordless telephone according to claim 1, further comprising an integrated pocket calendar.

11. The cordless telephone according to claim 1, wherein the telephone is constructed to: execute short message service functions, execute facsimile functions, execute mail functions, execute web browser functions, execute common business applications, update data, synchronize data with a PC, and be connected to an Internet.
